(19) United States
(12) Patent Application Publication
(10) Pub. No.: US 2021/0177196 A1
(43) Pub. Date: Jun. 17, 2021

(54) A LID FOR A FOOD PROCESSOR

(71) Applicant: BREVILLE PTY LIMITED, Alexandria (AU)

(72) Inventor: Gregory UPSTON, Alexandria (AU)

(21) Appl. No.: 17/256,971

(22) PCT Filed: Jun. 27, 2019
(86) PCT No.: PCT/AU2019/050676

§ 371 Date: Dec. 29, 2020

(30) Foreign Application Priority Data
Jun. 29, 2018 (AU) 2018902353

(51) Int. Cl. A47J 36/10; A47J 31/44; A47J 43/07; B65D 43/02

(52) U.S. Cl. CPC A47J 36/10; A47J 31/4407; B65D 2543/00555; A47J 43/0727; B65D 43/0208; A47J 43/0716

(57) ABSTRACT

A lid (116) for a food processor, the food processor including a hollow body (102) providing an interior chamber (103) to receive product and within which the product is processed, the body (102) having a sidewall (112) with an outwardly stepped rim portion (108) surrounding a body top opening (114), the rim portion (108) having a lip (109), the lid (116) including: a main part (118) to cooperate with the lip (109) to close the opening (114); and a skirt (120) to extend into the interior (103) of the body (102) and sealingly interface with an inner surface of the sidewall (112), wherein the skirt (120) is attached to the main part (118) at one end, and wherein the skirt (120) steps radially outwardly towards its other end to engage the stepped rim portion (108).

### FIELD

The present invention relates to a lid for a container, and more particularly, but not exclusively to a lid for a food processor such as a blender.

### BACKGROUND

A blender, is used to mix, stir, liquefy and otherwise process foods and beverages. A typical blender has a motorised base with rotating blades and a removable vessel in the form of a jug having an interior, the jug contents being isolated from the outside environment by a lid. The action of the rotating blades causes the contents to circulate around the vessel.

Accordingly, the lid is typically designed to withstand the forces exerted by the rising contents to securely seal the vessel. Disadvantageously, this results in a lid which is relatively difficult to remove readily or which may not adequately seal the vessel when the interior is subjected to a negative pressure.

### OBJECT

It is an object of the present invention to substantially overcome, or at least ameliorate, one or more of the above disadvantages, or to provide a useful alternative.

### SUMMARY OF INVENTION

There is disclosed herein, a lid for a food processor, the food processor including a hollow body providing an interior chamber to receive product and within which the product is processed, the body having a sidewall with an outwardly stepped rim portion surrounding a body top opening, the rim portion having a lip, the lid including:

a main part to cooperate with the lip to close the opening; and

a skirt to extend into the interior of the body and sealingly interface with an inner surface of the sidewall, wherein the skirt is attached to the main part at one end, and wherein the skirt steps radially outwardly towards its other end to engage the stepped rim portion.

Preferably, the skirt includes:

an upper portion attached to the main part; and

a lower portion having a peripheral seal to sealingly interface with the inner surface of the sidewall,

wherein the upper portion has a transverse width, and the lower portion has a transverse width, with the transverse width of the lower portion being greater than the transverse width of the upper portion.

Preferably, the main part includes a roof extending over the skirt, the roof including a plurality of latch members spaced apart around a periphery of the roof to releasably couple to the lip of the rim portion.

Preferably, the roof is interrupted by the latch members along the periphery of the roof so that the latch members can flex independently to the roof.

Preferably, each of the latch members include a projection to engage the lip to secure the main part to the body, wherein a portion of the projection is sloped to facilitate removal of the latch member from the lip when the projection is inclined relative to the lip.

Preferably, at least one of the latch members includes a pull tab to facilitate inclining the sloped portion of the projections of the other latch members toward the lip.

Preferably, the peripheral seal has a sealing projection to engage the stepped rim portion so that the sealing projection deflects into the inner surface of the sidewall to seal the body when the interior is subjected to a negative pressure relative to outside the interior.

There is also disclosed herein, in combination:

a container for a food processor, the container including a hollow body providing an interior chamber to receive product and within which the product is processed, the body having a sidewall with an outwardly stepped rim portion surrounding a body top opening, the rim portion having a lip; and

a removable lid to close the container, the lid including:
a main part to cooperate with the lip to close the opening; and
a skirt extending into the interior of the body to sealingly interface with an inner surface of the sidewall, wherein the skirt is attached to the main part at one end, and wherein the skirt steps radially outwardly towards its other end to engage the stepped rim portion.

Preferably, the rim portion has a transverse width which is greater than a transverse width of the rest of the body, wherein an abutment surface is formed at the boundary where the sidewall transitions from having a lesser transverse width to a greater transverse width.

Preferably, the skirt includes:

an upper portion attached to the main part; and

a lower portion having a peripheral seal to sealingly interface with the inner surface of the sidewall,

wherein the upper portion has a transverse width, and the lower portion has a transverse width, with the transverse width of the lower portion being greater than the transverse width of the upper portion.

Preferably, the peripheral seal includes a sealing projection to engage the abutment surface so that the sealing projection deflects into the inner surface of the sidewall to seal the body when the interior is subjected to a negative pressure relative to outside the interior.

Preferably, the main part includes a roof extending over the skirt, the roof including a plurality of latch members spaced apart around a periphery of the roof to releasably couple to the lip of the rim portion.

Preferably, the roof is interrupted by the latch members along the periphery of the roof so that the latch members can flex independently to the roof.

Preferably, each of the latch members include a projection to engage the lip to secure the main part to the body, wherein a portion of the projection is sloped to facilitate removal of the latch member from the lip when the projection is inclined relative to the lip.

Preferably, at least one of the latch members includes a pull tab to facilitate inclining the sloped portion of the projections of the other latch members toward the lip.

### BRIEF DESCRIPTION OF DRAWINGS

Exemplary embodiments of the present disclosure will now be described with reference to the accompanying description and drawings in which:

FIG. 1 is a perspective view of a blender jug with a lid and a lid cap;

FIG. 2 is a parts exploded isometric view of the jug, lid and lid cap of FIG. 1;

FIG. 3 is a first top plan view of the jug, lid and lid cap of FIG. 1;

FIG. 4 is a sectioned side elevation of the jug, lid and lid cap taken along line C-C of FIG. 3;

FIG. 5 is a second top plan view of the jug, lid and lid cap of FIG. 1;

FIG. 6 is a first side elevation of the jug, lid and lid cap of FIG. 1;

FIG. 7 is a second side elevation of the jug, lid and lid cap of FIG. 1;

FIG. 8 is a sectioned side elevation of the jug, lid and lid cap taken along line D-D of FIG. 5;

FIG. 9 is a third side elevation of the jug, lid and lid cap of FIG. 1;

FIG. 10 is an inverted parts exploded isometric view of the lid and the lid cap;

FIG. 11 is a first top plan view of the lid;

FIG. 12 is a first side elevation of the lid;

FIG. 13 is a sectioned side elevation of the lid taken along line D-D of FIG. 11;

FIG. 14 is a second top plan view of the lid;

FIG. 15 is a second side elevation of the lid;

FIG. 16 is a sectioned side elevation of the lid taken along line C-C of FIG. 14;

FIG. 17 is a detail view of a latch member and a seal of the lid cooperating with a sidewall of the jug;

FIG. 18 is a detail view of the latch member and the seal, showing a sealing projection of the seal deflecting into the sidewall;

FIG. 19 is a third top plan view of the lid;

FIG. 20 is a detail view of cut-outs on either side of the latch member;

FIG. 21 is a first partial side elevation of the lid showing the latch member;

FIG. 22 is a second partial side elevation of the lid showing the latch member;

FIG. 23 is a partial perspective view of the lid, showing the slope of a ledge of the latch member; and

FIG. 24 is an inverted parts exploded isometric view of the lid, showing a main part, a filament and a skirt.

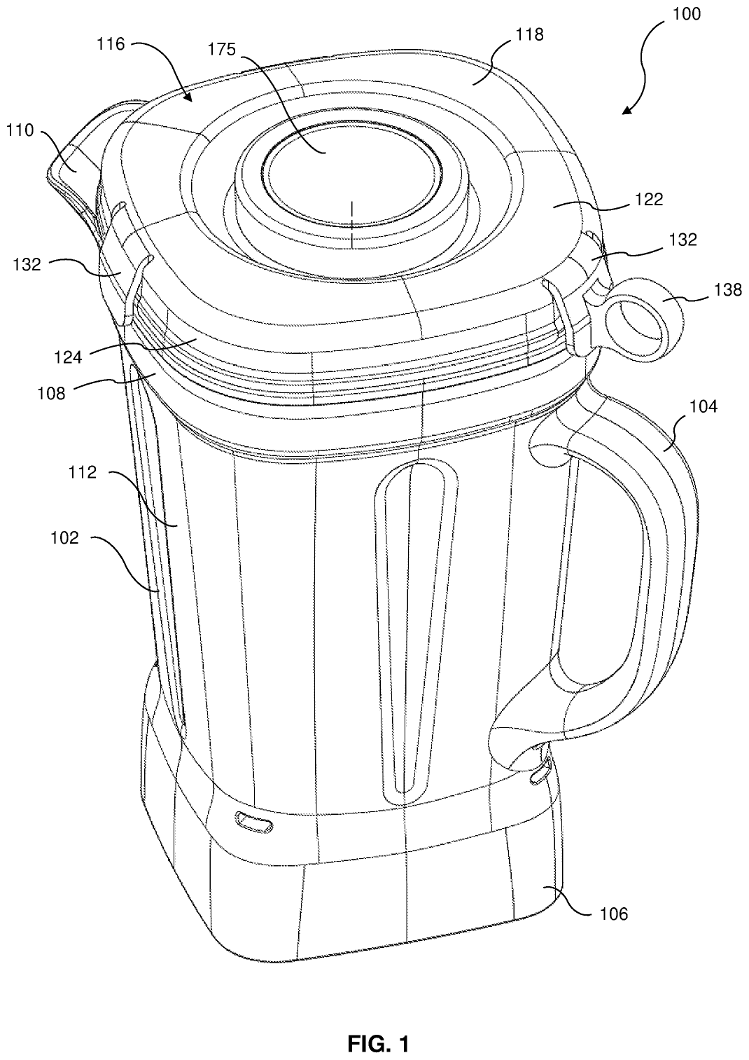

### DESCRIPTION OF EMBODIMENTS

In the accompanying drawings there is schematically depicted a container 100 within which food can be processed. As a particular example, the container 100 may be a container for a blender or other food processing apparatus within which a food product is engaged and processed in some form by a blade assembly 172 (shown in FIG. 4). The blade assembly 172 may be rotatably driven by a drive assembly (not shown) that includes a motor (not shown).

The container 100 includes a hollow vessel or body (jug) 102 having a handle 104 and a base 106 that engages the drive assembly for the food processor (blender). In this embodiment, the cross-sectional profile of the body 102 is generally rectangular and the container 100 has a generally central longitudinal axis 107.

The body 102 has an upper rim portion 108 that provides a pouring spout 110.

The body 102 has an interior 103 surrounded by a sidewall 112. A food product to be processed is delivered to the interior 103 where it is engaged by blades 173 (shown in FIG. 4) of the blade assembly 172 or other apparatus that are motor driven by the drive assembly.

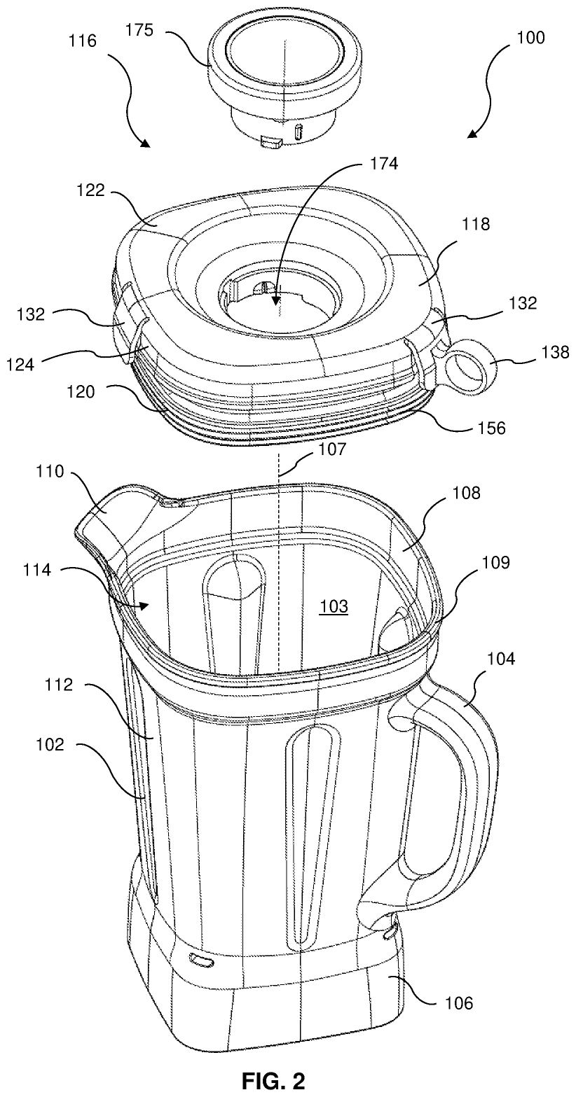

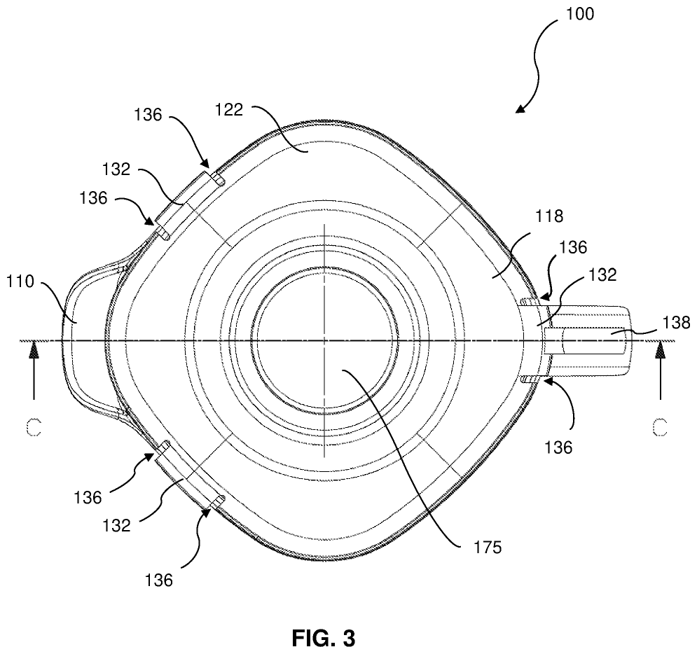

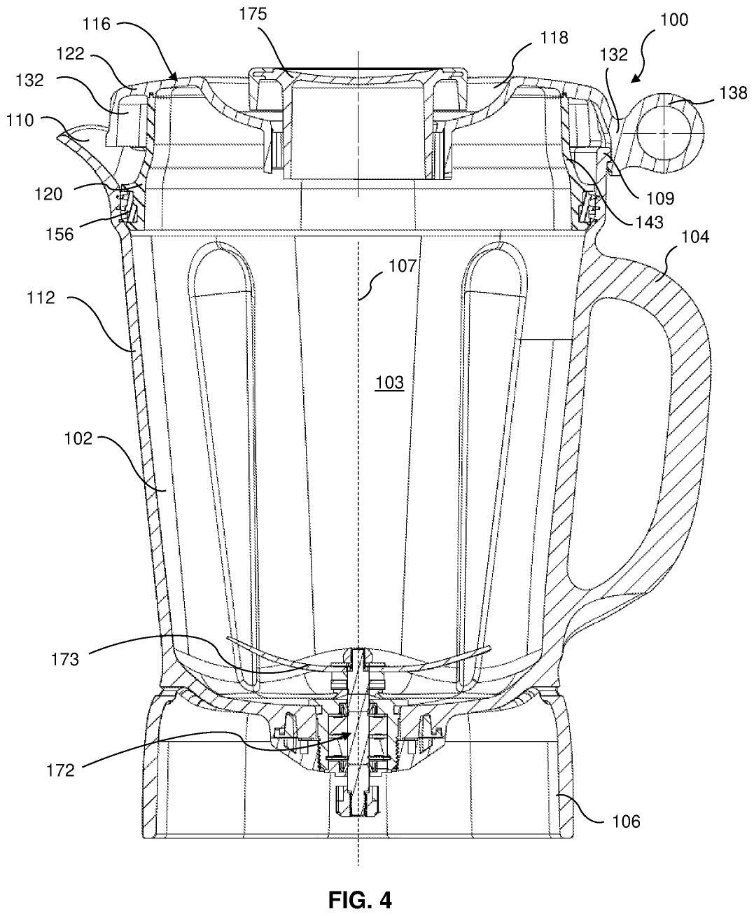

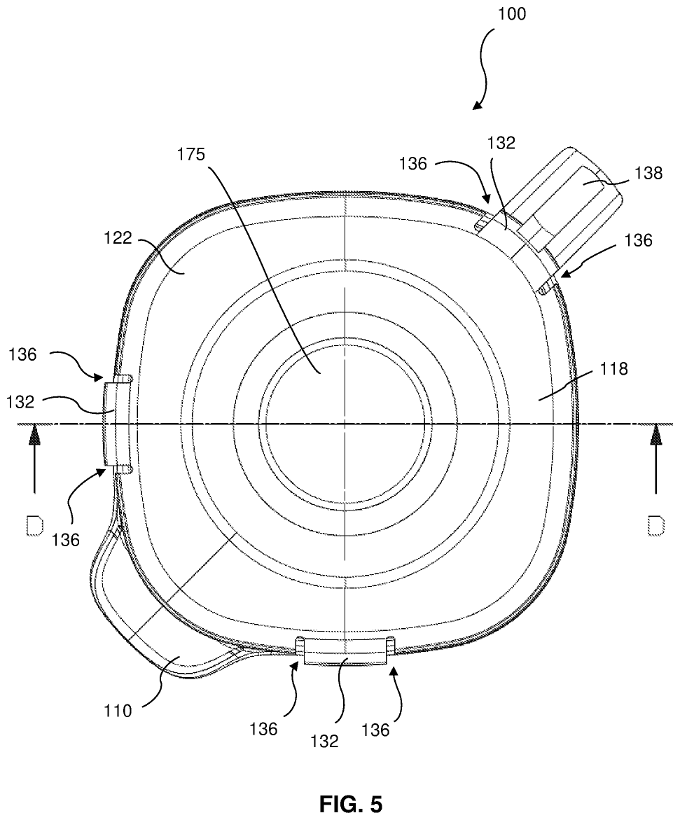

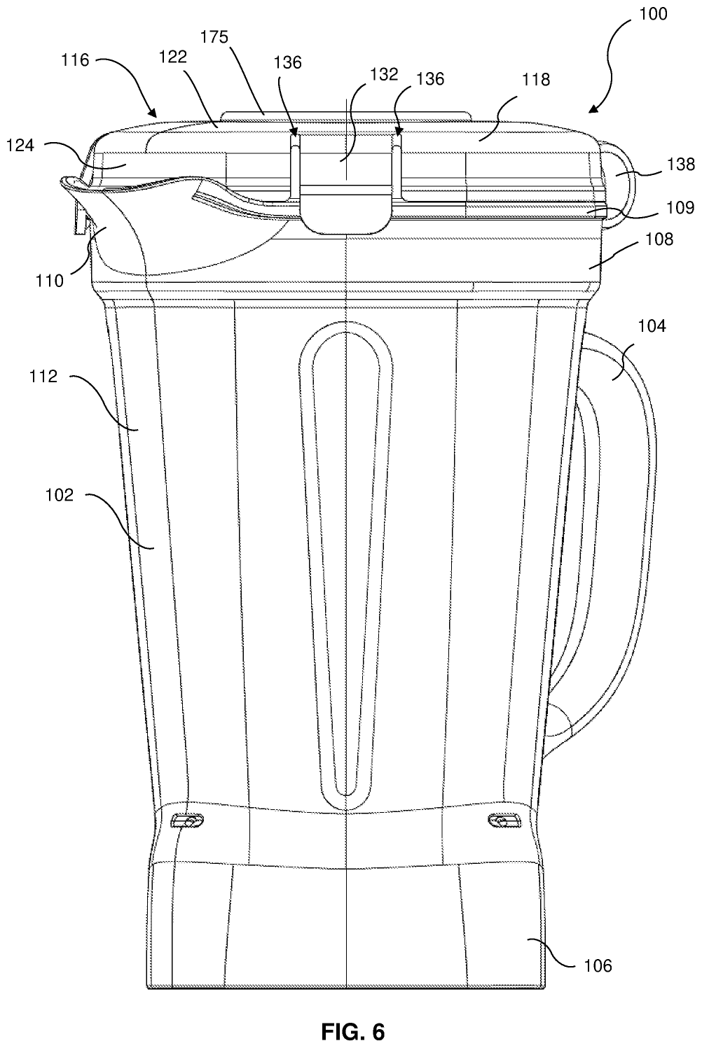

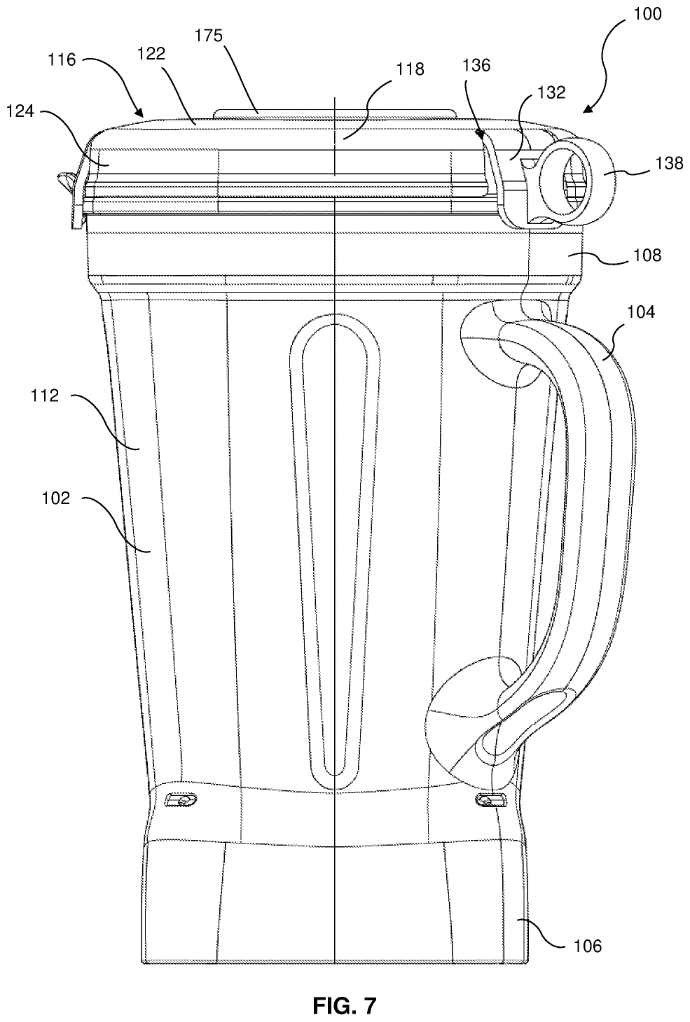

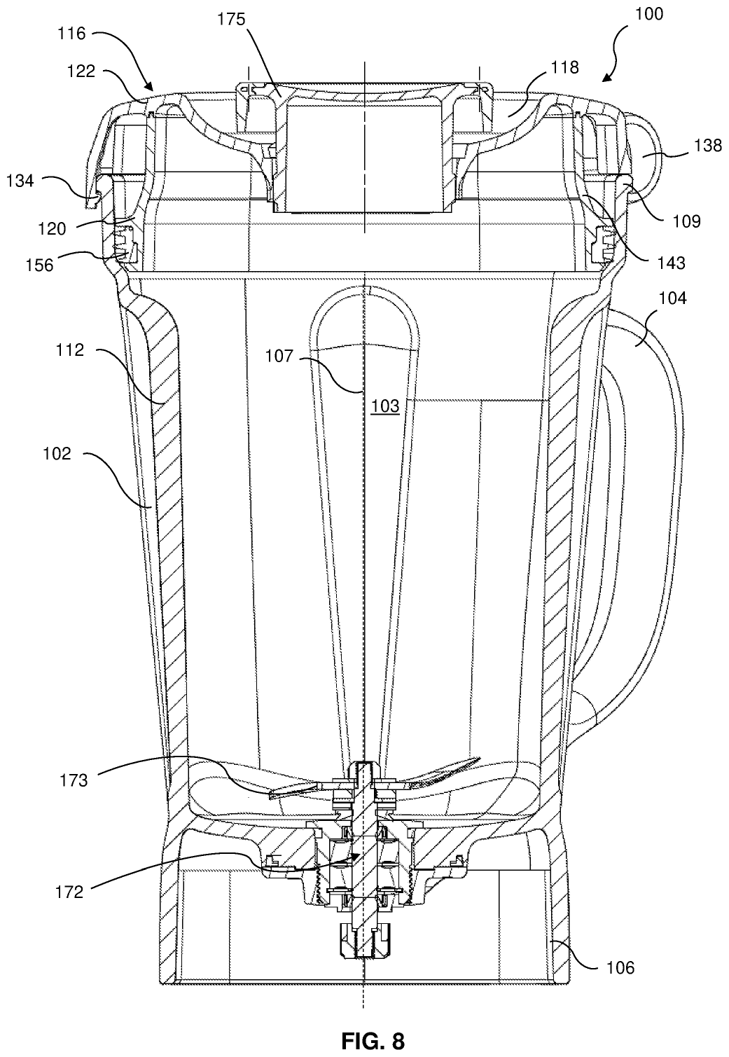

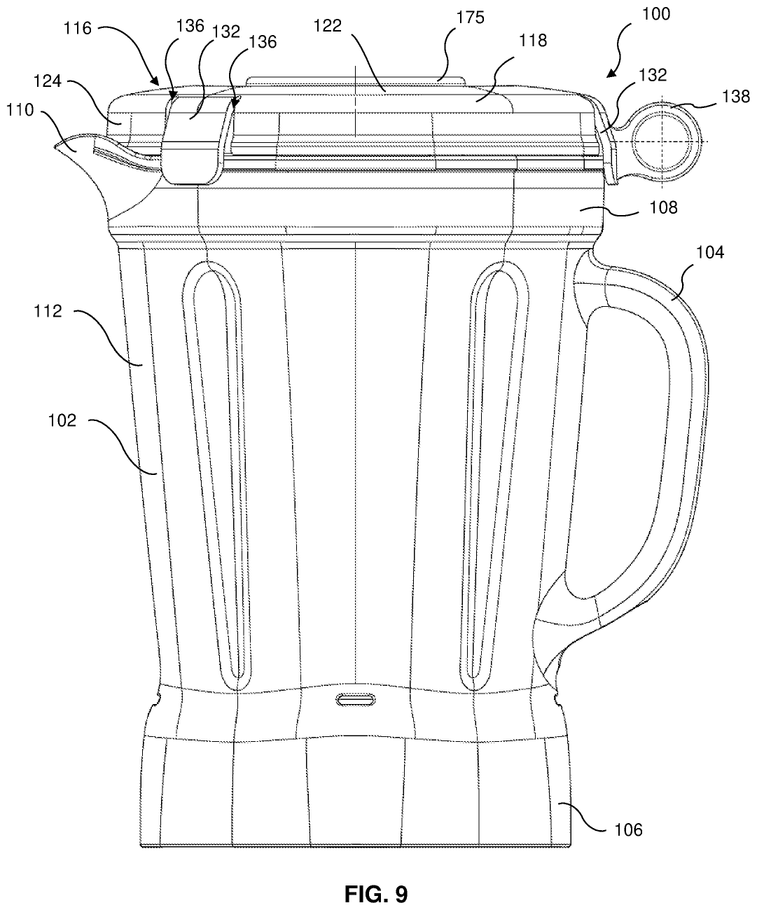

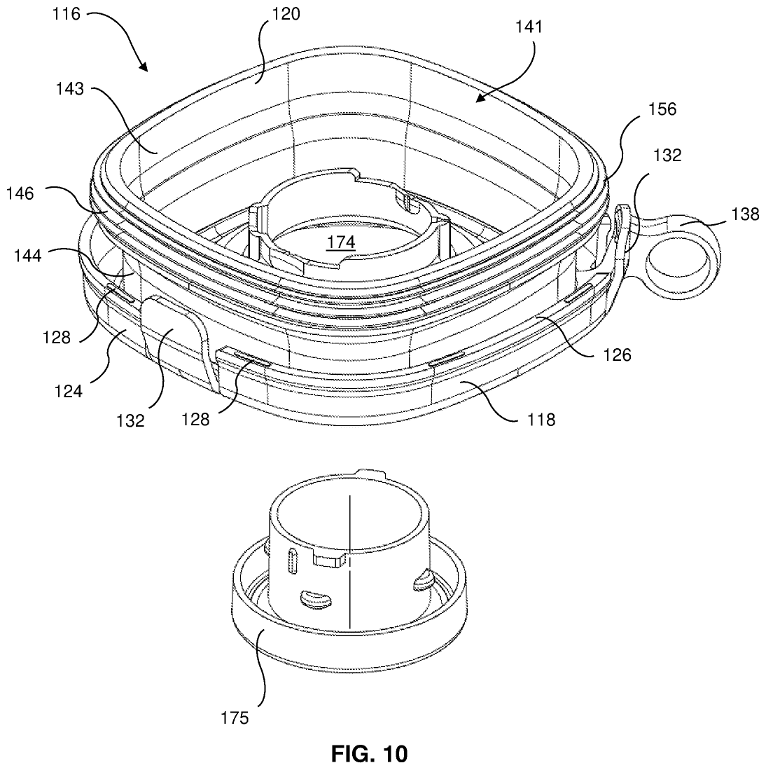

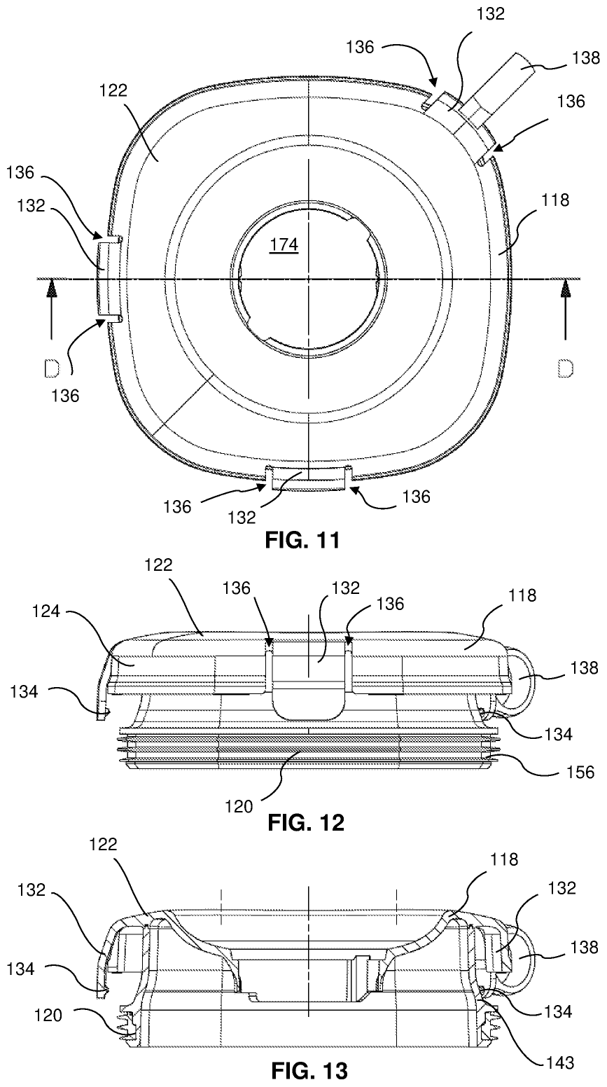

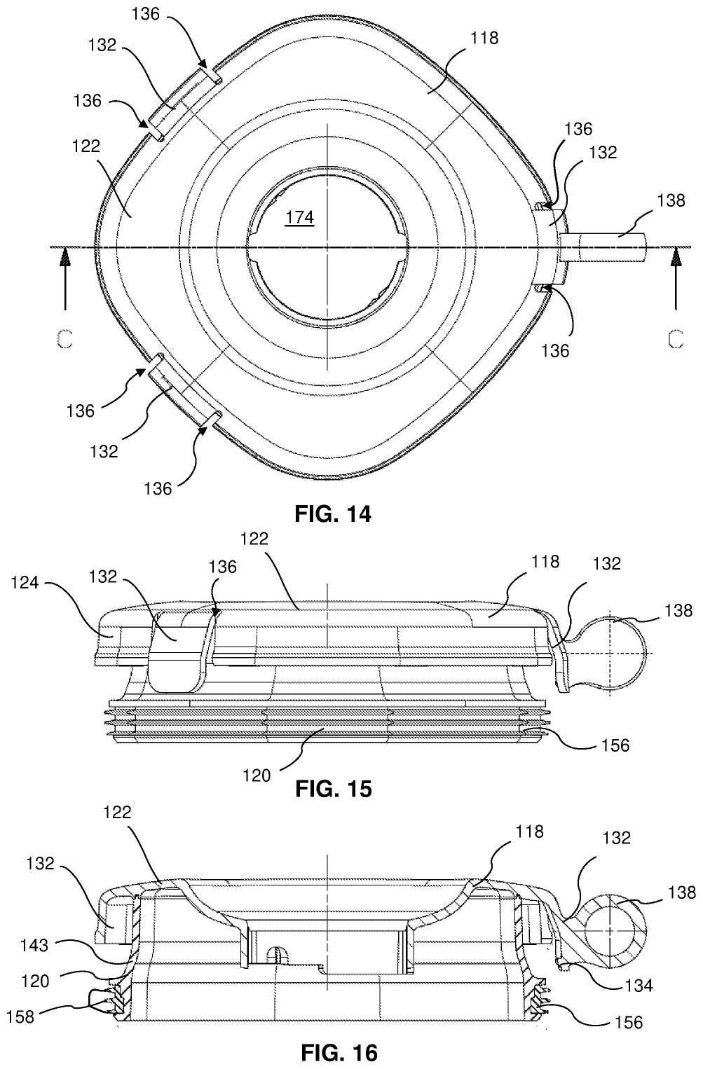

With particular reference to FIGS. 2, 17 and 18, a section of the sidewall 112 locating in the rim portion 108 is outwardly offset or stepped from the rest of the sidewall 112 such that the transverse width across the rim portion 108 is greater than the transverse width of the rest of the body 102. In this way, an abutment surface 113 is formed at the boundary where the sidewall 112 transitions from having a lesser transverse width to a greater transverse width.

A sealing face is defined by the inner surface of the sidewall 112 locating above the abutment surface 113 and below the level at which the spout 110 decays the inner surface of the sidewall 112 of the body 102.

Referring to FIG. 2, the rim portion 108 terminates in a lip 109 which surrounds a top opening 114 that is closed by means of a removable lid 116. The lip 109 extends outwardly from the opening 114 slightly past the rim portion 108. The profile of the opening 114 is generally rectangular apart from the spout 110.

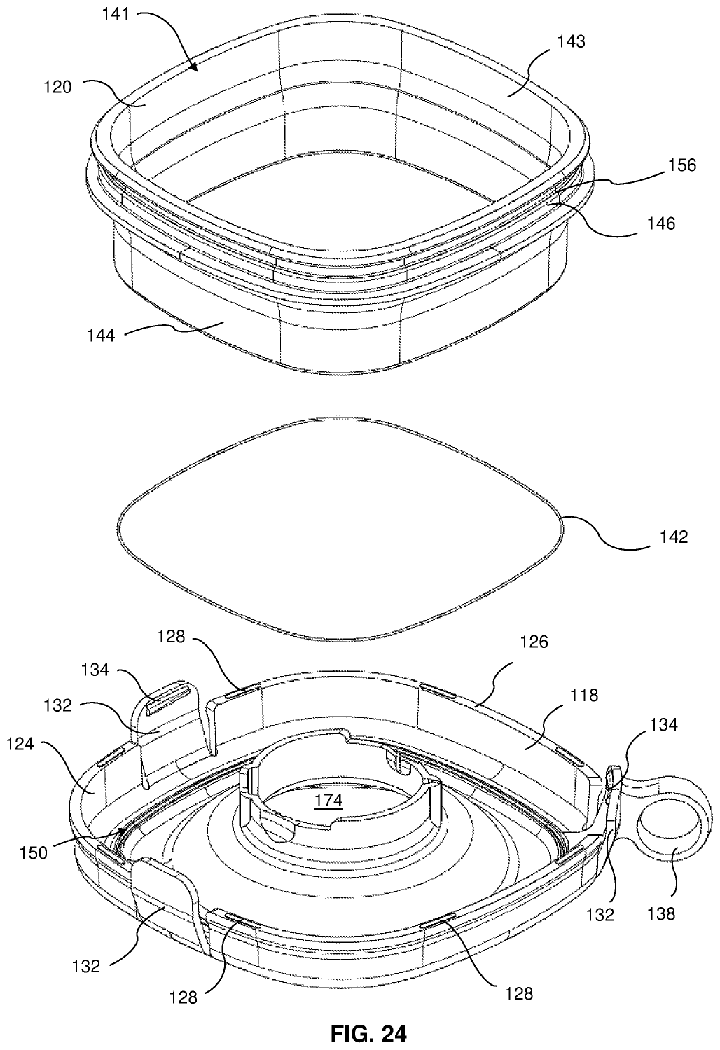

The lid 116 includes a main part 118 and a skirt 120 as best depicted in FIG. 24. The main part 118 and the skirt 120 are preferably constructed of polymer material.

The main part 118 is generally rectangular in configuration to close the opening 114. The main part 118 includes a roof 122 overhanging the skirt 120. The roof 122 includes a peripheral flange 124 that depends from the periphery of the roof 122 and extends generally in the direction along the axis 107 to a floor 126 of the flange 124. The floor 126 may include one or more foot pads 128 which rest on an upper surface 130 of the lip 109 when the opening 114 is closed by the main part 118.

The flange 124 is interrupted by a plurality of latch members 132 spaced apart around the roof 122. In the embodiment depicted, there are three latch members, with one of the latch members located at an edge of the roof 122 and the other two latch members each generally centered on the sides of the roof 122 opposite the edge. The latch members 132 extend from the periphery of the roof 122 generally in the direction along the axis 107 past the floor 126 of the flange 124.

As shown in FIG. 23, the latch members 132 are provided with protrusions in the form of ledges 134 extending transversely across an inner side surface of the latch members 132 proximal to the free hanging end of the latch members 132. When the main part 118 closes the opening 114, the ledges 134 locate under the lip 109 thereby latching the main part 118 to the rim portion 108 to securely close the opening 114.

Cut-outs 136 are provided either side of the latch members 132 and extend through the roof 122 and the flange 124 so that the latch members 132 can flex independently of the flange 124 and each other, thereby facilitating movement of the ledges 134 relative to the lip 109.

As best depicted in FIG. 23, each of the ledges 134 has an upper face 140 for engagement with an underside of the lip 109. The upper face 140 is defined by a generally flat surface 140a continuous with a sloped surface 140b. The flat surface 140a is approximately coplanar (typically within about 5 degrees) with a plane perpendicular to the axis 107. In this way, the flat surface 140a is configured to engage the underside of the lip 109 to resist positive pressure on the lid 116 that can be created within the body 102 (by certain liquid ingredients or when blending hot liquids, for example) but also to slidingly release from the lip 109 when encouraged.

The sloped surface 140b has an angle of depression, measured from the plane of the flat surface 140a, which gradually increases along the length of the sloped surface 140b, typically from 0 degrees, at the boundary between the sloped surface 140b and the flat surface 140a, to about 30 degrees, at the free end of the sloped surface 140b.

In the embodiment depicted, the latch member 132 which is located on the edge of the roof 122 includes a pull ring 138, preferably integrally formed with an outer side of the latch member 132, extending outwardly away from the latch member 132. The pull ring 138 allows a user (by using a finger, for example) to leverage the latch member 132 away from the body 102 in a first direction and a subsequent second direction. The first direction is generally along a plane perpendicular to the axis 107 to release the latch member 132 from the lip 109. The second direction is generally parallel to the axis 107 to lift and rotate the lid 116 around a fulcrum located on the diagonally opposite edge on the periphery of the roof 122. This rotation imparts a force upon the other two latch members thereby changing their angle of engagement with the lip 109. As the rotation of the lid 116 increases, each of the ledges 134 of the other two latch members is rotated relative to the underside of the lip 109 of the rim portion 108 thereby introducing the sloped surface 140b of the ledge 134 to the underside of the lip 109 which acts to encourage the latch members 132 to flex and release the ledge 134 from the lip 109 to thereby remove the lid 116 from the body 102.

The upper face 140 of the ledge 134 is thus configured to encourage resistance against the flex of the latch member 132 when in the plane perpendicular to the axis 107 and subsequently encourage flex of the latch member 132 as the ledge 134 is rotated to engage the sloped surface 140b with the lip 109.

The main part 118 may optionally include a central aperture 174 closable by a removable lid cap 175 which may be in the form of a measuring cup, for example. In alternative embodiments, the lid cap 175 may be replaced by a vacuum device (not shown) configured to hold a negative pressure within the body 102.

The skirt 120 is generally rectangular in configuration to complement the cross-sectional profile of the body 102. The skirt has an open end 141 to allow food product to be processed to be delivered to the interior 102. The skirt 120 and the main part 118 are welded together using a process of induction welding. In this process, a thin metallic wire filament (ferrous) 142 is enclosed within a trench located at the upper perimeter of the skirt 120. The skirt 120 and the main part 118 together with the filament 142 are placed within a magnetic field induced by a coil (not shown) with an electric current whereby the field induces heat within the filament 142 and causes both the main part 118 and the skirt 120 to be locally heated to melt temperature. The skirt 120 and the main part 118 are pressed together during this process and the locally melted polymer freezes to bond the skirt 120 and the main part 118 when the induction field is removed.

The skirt 120 is defined by a generally rectangular tubular sidewall 143 having an upper portion 144 and a lower portion 146. The sidewall 143 steps or flares out as the upper portion 144 transitions into the lower portion 146. In this way, the transverse width of the lower portion 146 is greater than the transverse width of the upper portion 144.

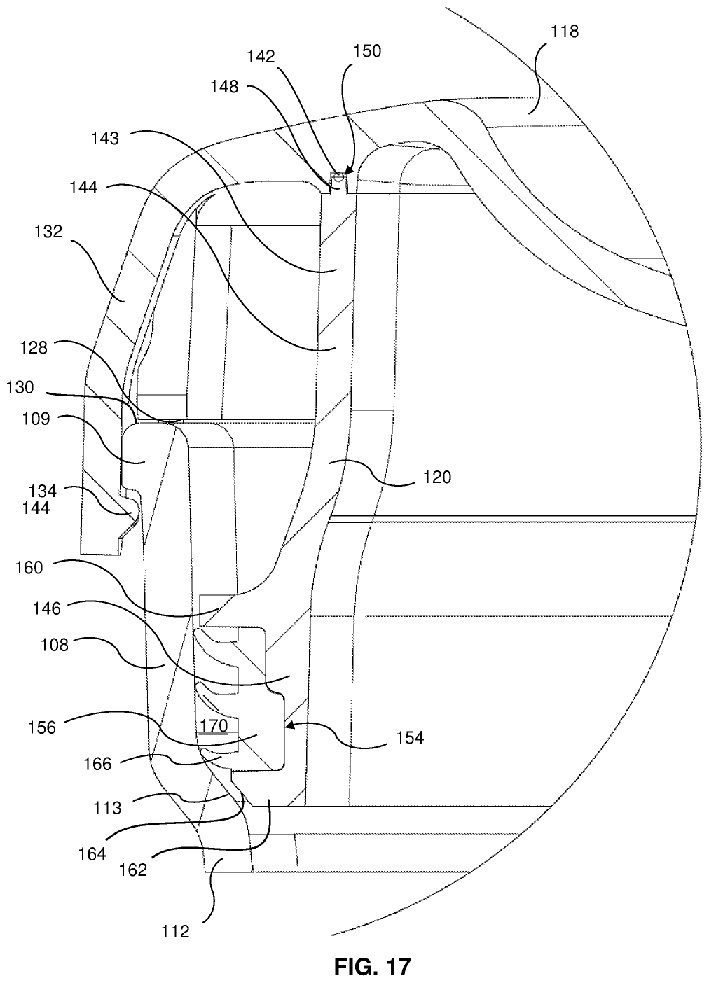

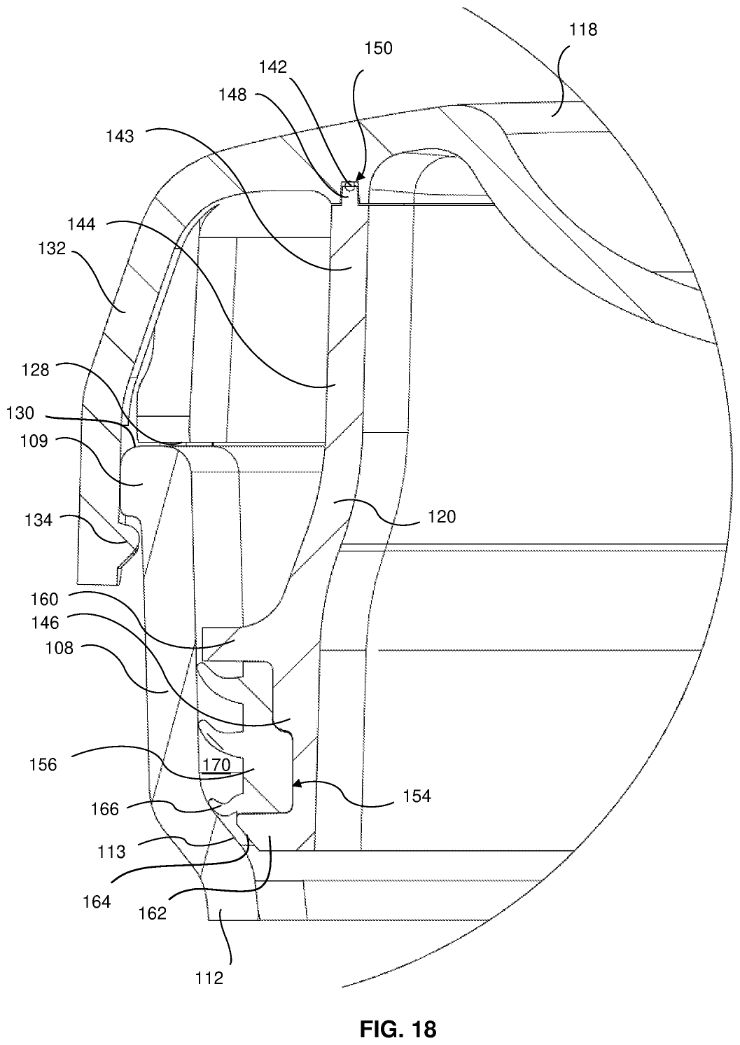

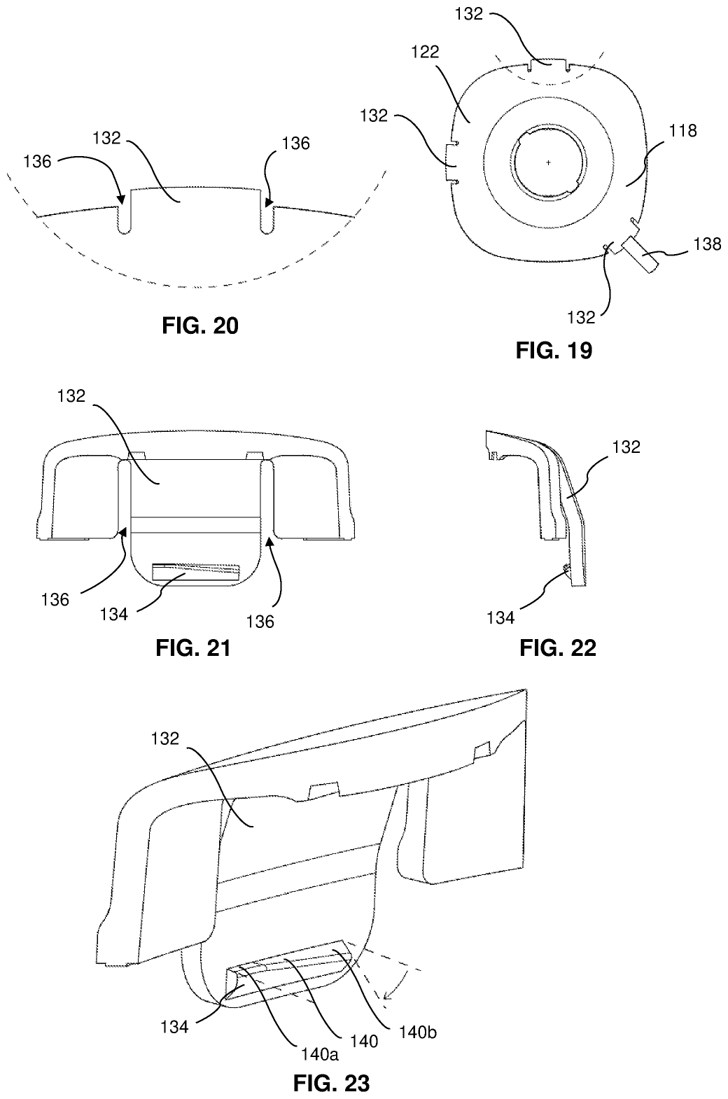

As best depicted in FIGS. 17 and 18, a ridge 148 is provided along the upper periphery of the upper portion 144 extending outwardly away from the upper portion 144 to be received in a complementary groove 150 formed in the underside of the main part 118 in the region where the skirt 120 and the main part 118 are bonded together.

A recess 154 is formed in the lower portion 146 of the skirt 120 to house a seal 156. The seal 156 is constructed of a polymer, preferably an elastomer to flex against the sidewall 112. The recess 154 terminates to form a ceiling 160 and a lower edge 162 that forms the lowest extent of the sidewall 143. The edge 162 preferably features a chamfer 164 that borders a gap with the side wall 112 to allow at least some amount of pressurized air to escape in situations where the user removes the seal 156 and fails to replace before blending.

The seal 156 has multiple flexible finger-like projections 158 extending around the periphery of the seal 156. The projections 158 sealingly interface with the sealing face of the sidewall 112 of the body 102 to sealingly connect the skirt 120 with the body 102 to prevent ingredients (liquid) being transferred to the upper side of the projections 158 during blending. As shown in FIG. 18, a lower projection 166 is configured to cooperate with the abutment surface 113 so that when a vacuum is enacted within the interior 103 of the body 102 (using the vacuum device mentioned above, for example) the lower projection 166 will deflect into the abutment surface 113 to increase the interference and sealing force as the lower projection 166 deforms. In this way, the abutment surface 113 provides a vertical stop for the lower projection 166 to engage with to substantially minimize the tendency for the lower projection 166 to flex downward under the forces of negative pressure.

The above preferred embodiment has a number of advantages including the skirt 120 flaring or stepping out to meet the stepped-out sidewall 112 of the container 100, so that the first projection 166 falls onto the abutment surface 113 to provide an improved seal between the lid 116 and the body 102 when a negative pressure is applied to the interior 103. In this way, the seal 156 is configured to seal in both a positive pressure environment (hot soup being blended for example) and a negative pressure environment (when a negative pressure is applied by an external vacuum device, for example).

A further advantage of the above described preferred embodiment is having the sloped surface 140b on the ledges 134 to assist release of the latch members 132 from the lip 109 when using the pull ring 138 to lift the lid 116 to thereby reduce the force required to remove the lid 116 from the body 102.

1. A lid for a food processor, the food processor including a hollow body providing an interior chamber to receive product and within which the product is processed, the body having a sidewall with an outwardly stepped rim portion surrounding a body top opening, the rim portion having a lip, the lid including:
a main part to cooperate with the lip to close the opening; and
a skirt to extend into the interior of the body and sealingly interface with an inner surface of the sidewall, wherein the skirt is attached to the main part at one end, and wherein the skirt steps radially outwardly towards its other end to engage the stepped rim portion.

2. The lid of claim 1, wherein the skirt includes:
an upper portion attached to the main part; and
a lower portion having a peripheral seal to sealingly interface with the inner surface of the sidewall,
wherein the upper portion has a transverse width, and the lower portion has a transverse width, with the transverse width of the lower portion being greater than the transverse width of the upper portion.

3. The lid of claim 2, wherein the main part includes a roof extending over the skirt, the roof including a plurality of latch members spaced apart around a periphery of the roof to releasably couple to the lip of the rim portion.

4. The lid of claim 3, wherein the roof is interrupted by the latch members along the periphery of the roof so that the latch members can flex independently to the roof.

5. The lid of claim 4, wherein each of the latch members include a projection to engage the lip to secure the main part to the body, and wherein a portion of the projection is sloped to facilitate removal of the latch member from the lip when the projection is inclined relative to the lip.

6. The lid of claim 5, wherein at least one of the latch members includes a pull tab to facilitate inclining the sloped portion of the projections of the other latch members toward the lip.

7. The lid of any one of claims 2 to 6, wherein the peripheral seal has a sealing projection to engage the stepped rim portion so that the sealing projection deflects into the inner surface of the sidewall to seal the body when the interior is subjected to a negative pressure relative to outside the interior.

8. In combination:
a container for a food processor, the container including a hollow body providing an interior chamber to receive product and within which the product is processed, the body having a sidewall with an outwardly stepped rim portion surrounding a body top opening, the rim portion having a lip; and
a removable lid to close the container, the lid including:
a main part to cooperate with the lip to close the opening; and
a skirt extending into the interior of the body to sealingly interface with an inner surface of the sidewall, wherein the skirt is attached to the main part at one end, and wherein the skirt steps radially outwardly towards its other end to engage the stepped rim portion.

9. The combination of claim 8, wherein the rim portion has a transverse width which is greater than a transverse width of the rest of the body, wherein an abutment surface is formed at the boundary where the sidewall transitions from having a lesser transverse width to a greater transverse width.

10. The combination of claim 9, wherein the skirt includes:
an upper portion attached to the main part; and
a lower portion having a peripheral seal to sealingly interface with the inner surface of the sidewall,
wherein the upper portion has a transverse width, and the lower portion has a transverse width, with the transverse width of the lower portion being greater than the transverse width of the upper portion.

11. The combination of claim 10, wherein the peripheral seal includes a sealing projection to engage the abutment surface so that the sealing projection deflects into the inner surface of the sidewall to seal the body when the interior is subjected to a negative pressure relative to outside the interior.

12. The combination of claim 11, wherein the main part includes a roof extending over the skirt, the roof including a plurality of latch members spaced apart around a periphery of the roof to releasably couple to the lip of the rim portion.

13. The combination of claim 12, wherein the roof is interrupted by the latch members along the periphery of the roof so that the latch members can flex independently to the roof.

14. The combination of claim 13, wherein each of the latch members include a projection to engage the lip to secure the main part to the body, wherein a portion of the projection is sloped to facilitate removal of the latch member from the lip when the projection is inclined relative to the lip.

15. The combination of claim 14, wherein at least one of the latch members includes a pull tab to facilitate inclining the sloped portion of the projections of the other latch members toward the lip.
